(19) United States
(12) Patent Application Publication
(10) Pub. No.: US 2026/0267959 A1
(43) Pub. Date: Sep. 10, 2026

(54) BACKDOOR INSPECTION APPARATUS, BACKDOOR INSPECTION METHOD, AND BACKDOOR INSPECTION PROGRAM

(71) Applicant: NEC Corporation, Tokyo (JP)

(72) Inventor: Daiki TANAKA, Tokyo (JP)

(73) Assignee: NEC Corporation, Tokyo (JP)

(21) Appl. No.: 19/165,612

(22) PCT Filed: Mar. 23, 2023
(86) PCT No.: PCT/JP2023/011384

§ 371 Date: Sep. 16, 2025

(51) Int. Cl. G06F 21/52

(52) U.S. Cl. CPC G06F 21/52; G06F 2221/033

(57) ABSTRACT

A backdoor inspection apparatus includes: an execution path extraction part that analyzes a program(s) to extract execution path(s); an external input branch extraction part that extracts, as external input branch(es), conditional branch(es) that includes at least one external input as a condition from conditional branch(es) included in the execution path(s); an authentication branch determination part that extracts conditional branch(es) that includes a plurality of different external inputs as conditions from the external input branch(es) as authentication branch(es) that determines whether authentication succeeds or fails; and a backdoor determination part that determines any execution path that bypasses both the authentication branch(es) and function(s) used for authentication to be a probable backdoor.

### TECHNICAL FIELD

The present invention relates to a backdoor inspection apparatus, backdoor inspection method, and backdoor inspection program.

### BACKGROUND

As one of measures for supply chain risk management, detection of malicious functions within software, known as backdoors, has become increasingly important. Current computer systems have become so complex that it is difficult to configure them using only products from a single company. Therefore, it is common to procure parts externally and assemble the procured parts to configure a system. In this process, the manufacturers of the procured parts and the supply chains are assumed to be trustworthy because backdoor detection is required as part of the process.

However, detecting backdoors in software requires significant time and effort without having source code since such a task would entail reverse engineering, analyzing suspicious functions and execution paths in detail, and manually narrowing down them through to find backdoors. For example, Patent Literature 1 proposes a technique that defines as policies library functions and system calls, which are often used for backdoors, and identifies in a program these critical functions and the execution paths that call them.

### CITATION LIST

### Patent Literature

### Patent Literature 1

International Publication Number WO2021/028989A1

### Technical Problem

The disclosure of each literature cited above is incorporated herein in its entirety by reference thereto. The following analysis is provided by the present inventors.

Although there are tools available to support the detection of backdoors, they can only identify execution paths leading to malicious functions added by attackers as highly likely backdoors and fail to detect backdoor execution paths that bypass authentication mechanisms through external input. As a result, it is difficult to efficiently narrow down execution paths that are likely to be backdoors, leaving the inspection process burdened with significant workload.

In view of the problem above, it is an object of the present invention to provide a backdoor inspection apparatus, backdoor inspection method, and backdoor inspection program that contribute to efficiently narrowing down execution path(s) that is likely to be backdoor(s).

### Solution to Problem

According to a first aspect of the present invention, there is provided a backdoor inspection apparatus including: an execution path extraction part that analyzes a program(s) to extract execution path (s); an external input branch extraction part that extracts, as external input branch(es), conditional branch(es) that includes at least one external input as a condition from conditional branch(es) included in the execution path(s); an authentication branch determination part that extracts conditional branch(es) that includes a plurality of different external inputs as conditions from the external input branch(es) as authentication branch(es) that determines whether authentication succeeds or fails; and a backdoor determination part that determines any execution path that bypasses both the authentication branch(es) and function(s) used for authentication to be a probable backdoor.

According to a second aspect of the present invention, there is provided a backdoor inspection method including: analyzing a program(s) to extract execution path(s); extracting as external input branch(es) conditional branch(es) that includes at least one external input as a condition from conditional branch(es) included in the execution path(s); extracting conditional branch(es) that includes a plurality of different external inputs as conditions from the external input branch(es) as authentication branch(es) that determines whether authentication succeeds or fails; and determining any execution path that bypasses the authentication branch(es) and function(s) used for authentication to be a probable backdoor.

According to a third aspect of the present invention, there is provided a backdoor inspection program causing an information processing apparatus to execute: an execution path extraction process of analyzing a program(s) to extract execution path (s); an external input branch extraction process of extracting as external input branch(es) conditional branch(es) that includes at least one external input as a condition from conditional branch(es) included in the execution path (s); an authentication branch determination process of extracting conditional branch(es) that includes a plurality of different external inputs as conditions from the external input branch(es) as authentication branch(es) that determines whether authentication succeeds or fails; and a backdoor determination process of determining any execution path that bypasses the authentication branch(es) and function(s) used for authentication to be a probable backdoor.

Further, the program(s) can be stored in a computer-readable storage medium. The storage medium may be a non-transitory one such as a semiconductor memory, a hard disk, a magnetic recording medium, an optical recording medium, and the like. The present invention can also be realized as a computer program product.

### Advantageous Effects of Invention

According to each aspect of the present invention, there can be provided a backdoor inspection apparatus, backdoor inspection method, and backdoor inspection program that contribute to efficiently narrowing down execution path(s) that is likely to be backdoor(s).

### BRIEF DESCRIPTION OF DRAWINGS

FIG. 1 FIGS. 1A, 1B, and 1C are diagrams showing three types of conditional branches in execution paths.

FIG. 2 FIGS. 2A and 2B are diagrams illustrating examples of processing flows: one having an authentication function and another of an authentication bypass backdoor.

FIG. 3 is a diagram schematically illustrating a configuration of a backdoor inspection apparatus relating to an example embodiment of the present invention.

FIG. 4 is a diagram describing a process performed by an execution path extraction part.

FIG. 5 is a diagram describing a process performed by an external input branch extraction part.

FIG. 6 is a diagram describing a process performed by an authentication branch determination part.

FIG. 7 is a diagram describing a process performed by a backdoor determination part.

FIG. 8 is a diagram illustrating a hardware configuration example of the backdoor inspection apparatus used in the example embodiment.

### EXAMPLE EMBODIMENTS

The following describes an example embodiment of the present invention with reference to the drawings. The present invention, however, is not limited to the example embodiment described below. Further, in each drawing, the same or corresponding elements are appropriately designated by the same reference signs. It should be noted that the drawings are schematic, and the dimensional relationships and the ratios between the elements may differ from the actual ones. The dimensional relationships and the ratios between the drawings may also be different in some sections.

First, the following describes a basic concept of the present invention. A backdoor inspection apparatus, backdoor inspection method, and backdoor inspection program relating to the example embodiment of the present invention identify function(s) with authentication capability/capabilities and conditional branch(es) that determine success or failure of authentication and deem execution path(s) that bypass these elements highly likely to represent backdoor(s) that circumvent authentication. In other words, the backdoor inspection method and the backdoor inspection program, having the following capabilities, notify an inspector(s) of execution path(s) within a program(s) that are most likely to be backdoor execution path(s).
1. Manage an “execution path list(s)” extracted from a program(s), along with an “authentication function list(s)” and an “authentication branch list(s),” prepared in advance.
2. Evaluate conditional branch(es) encountered before reaching a specified program point in a certain execution path in the “execution path list(s)” using an authentication branch determination method described later and store a conditional branch in the “authentication branch list(s)” if it is determined to be an authentication function.
3. Notify the inspector(s) that a certain execution path in the “execution path list(s)” is likely to be a backdoor execution path if it is found to bypass both authentication function(s) and authentication branch(es) by referring to the “authentication function list(s)” and the “authentication branch list(s).”

### Authentication Branch Determination Method

Authentication functions used by applications generally fall into two cases: (1) a case where an application relies on a known authentication API provided by the operating system or its built-in modules; and (2) a case where an application implements their own authentication mechanisms or utilizes a database.

Examples of (1): Remote login services such as SSH or Telnet that utilize PAM (pluggable authentication module).

Examples of (2): BASIC authentication handled by HTTP servers such as Apache.

In case (1), authentication components within a program can be identified by preparing in advance a list of library functions that require authentication as a knowledge base. For instance, in Linux (registered trademark), a widely used function that requires authentication using PAM is “pam_authenticate.”

In case (2), authentication components within a program can be identified by finding conditional branche(s) that compares user-provided input such as IDs and passwords (hereafter referred to as “requested data”) with data retrieved from password files or databases (hereafter referred to as “authentication data”).

An authentication-related branching condition is characterized by nature of data compared against external input. For authentication data, an external source such as a database or a password file is utilized and compared with data entered by an attacker. In contrast, a backdoor trigger such as a hidden account inserted by an attacker is hardcoded in a program. Since attackers aim to leave minimal traces, it is unlikely that they would store unnecessary information outside the program. Further, error checks are also generally performed by comparing input with hardcoded strings or constants within a program.

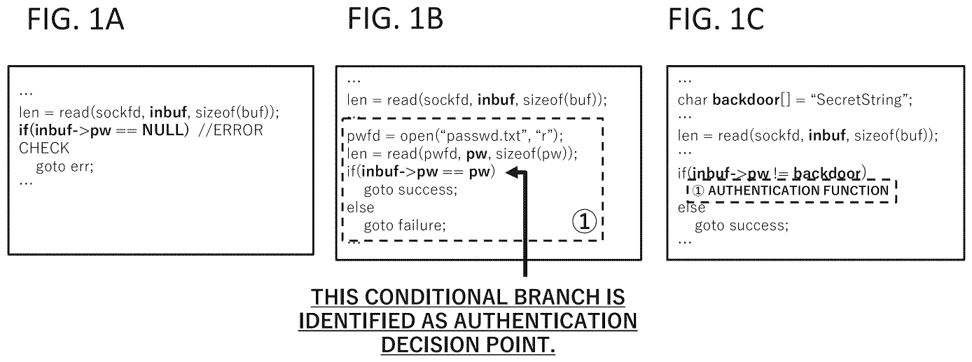

Therefore, as illustrated in FIGS. 1A, 1B, and 1C, conditional branches in execution paths can be classified into three types. In FIG. 1A, comparison is made between an external input and a constant, making it unlikely to be an authentication-related branch. In FIG. 1B, comparison is made between two external inputs, making it likely to be an authentication-related branch. Meanwhile, FIG. 1C shows a comparison between a hardcoded string in the program and an external input, which can be used to bypass authentication, suggesting a high possibility of being a backdoor.

By focusing on these characteristics, one can detect execution path(s) with a high likelihood of being backdoor(s) as follows:

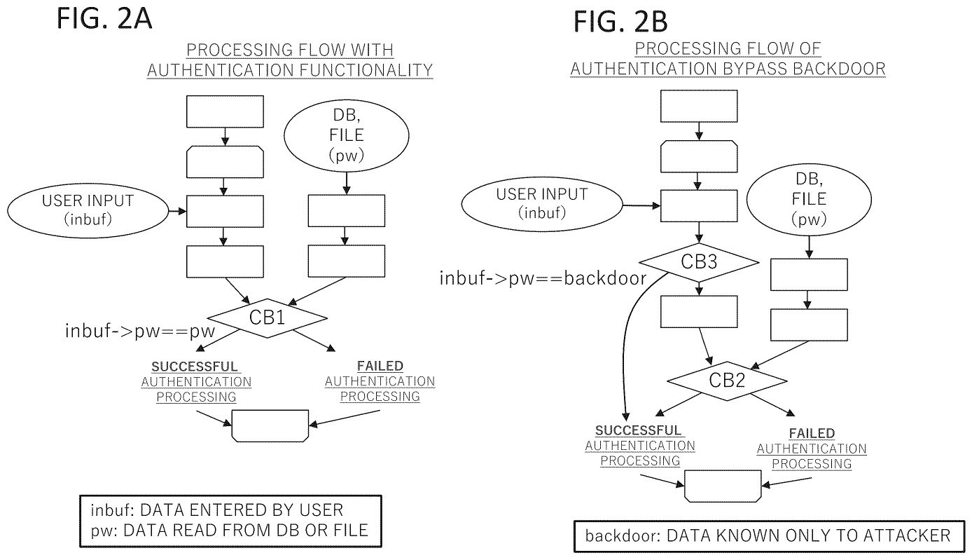

FIGS. 2A and 2B are diagrams illustrating examples of processing flows: one having an authentication function and another of an authentication bypass backdoor. FIG. 2A shows an example of a processing flow with authentication functionality while FIG. 2B depicts the processing flow of the authentication bypass backdoor. As shown in FIG. 2A, in the example of the processing flow with authentication functionality, a conditional branch CBI compares requested data (inbuf) entered by a user(s) with authentication data (pw) retrieved from a database(s) or file(s). If the requested data (inbuf) matches the authentication data (pw), successful authentication processing is performed. If not, failed authentication processing is performed. Although the flow shown in FIG. 2A includes the conditional branch CB1, it is a normal authentication check and poses a low risk of being a backdoor. Meanwhile, as shown in FIG. 2B, in the processing flow example of the authentication bypass backdoor, a conditional branch CB3 compares requested data (inbuf) entered by a user(s) with data (backdoor) known only to an attacker. If the requested data (inbuf) matches the data (backdoor), one is able to proceed to successful authentication processing, bypassing a conditional branch CB2. A conditional branch(es) like CB3, which compares the data (backdoor) coded in a program with the request data (inbuf) entered by the user(s), can be strongly suspected as a backdoor trigger.

By implementing the basic concept of the present invention described above, it becomes possible to automatically narrow down execution path(s) most likely to be authentication bypass backdoor(s) from one(s) leading to function(s) that can have a large impact if exploited through external input(s), significantly reducing workload on an analyst(s).

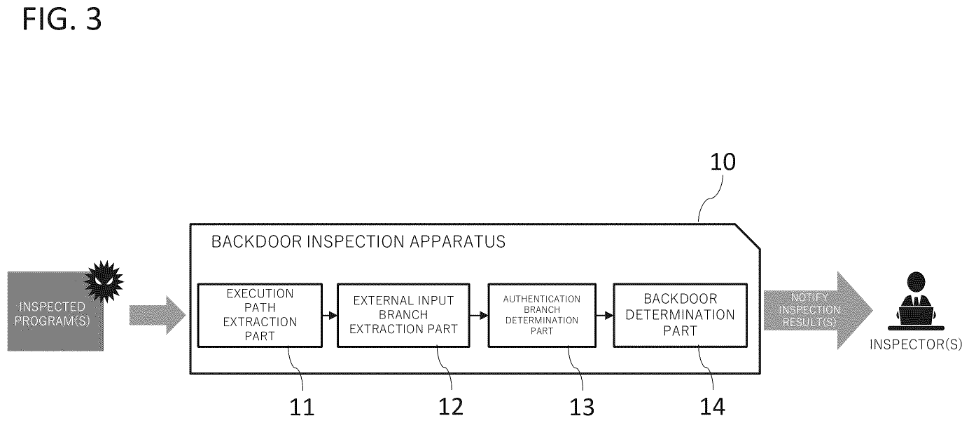

FIG. 3 is a diagram schematically illustrating a configuration of a backdoor inspection apparatus relating to an example embodiment of the present invention. As shown in FIG. 3, the backdoor inspection apparatus 10 includes an execution path extraction part 11, an external input branch extraction part 12, an authentication branch determination part 13, and a backdoor determination part 14.

The execution path extraction part 11 analyzes a program(s) to extract execution path(s), the external input branch extraction part 12 extracts, as external input branch(es), conditional branch(es) that include at least one external input as a condition from conditional branch(es) included in the execution path(s), the authentication branch determination part 13 extracts conditional branch(es) that include a plurality of different external inputs as conditions from the external input branch(es) as authentication branch(es) that determine whether authentication succeeds or fails, and the backdoor determination part 14 determines any execution path that bypasses both the authentication branch(es) and function(s) used for authentication to be a probable backdoor.

Noted that the process(es) performed by each component of the backdoor inspection apparatus 10 can also be implemented as a backdoor inspection method. Additionally, the process(es) performed by each component of the backdoor inspection apparatus 10 can be realized as a program(s) executed by an information processing apparatus. The following describes in more detail the process(es) performed by each component of the backdoor inspection apparatus 10.

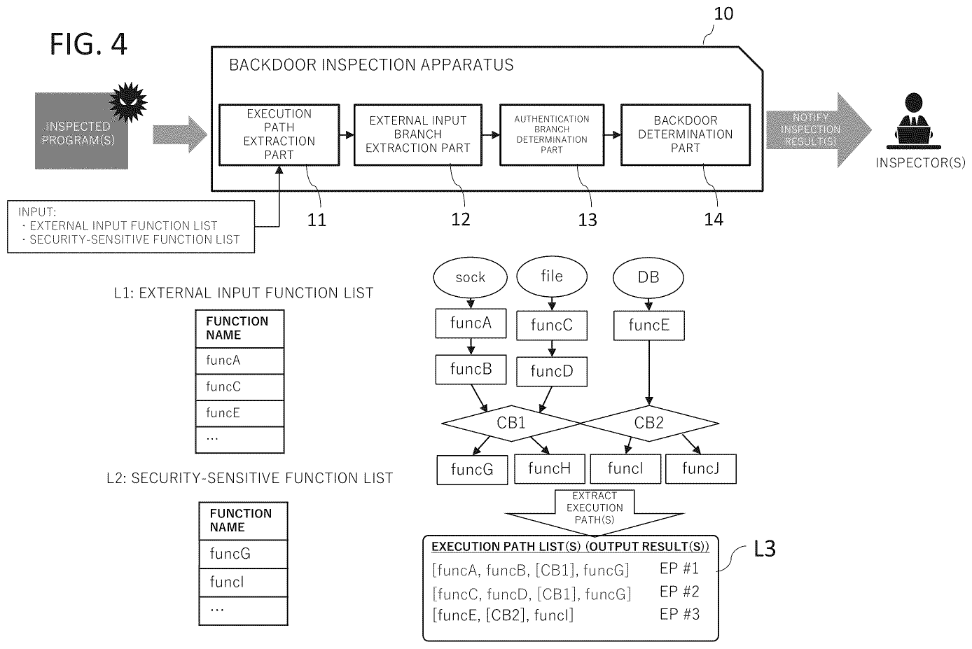

FIG. 4 is a diagram describing a process performed by the execution path extraction part. As illustrated in FIG. 4, a sensitive function list(s) L2 containing critical function(s), to be analyzed, that can have a large impact on a system(s) if exploited and an external input function list(s) L1 containing function(s) that define variable(s) using external input(s) are provided to the execution path extraction part 11. The execution path extraction part 11 refers to the sensitive function list(s) L2 and the external input function list(s) L1 and extracts execution path(s) that leads from function(s) listed in the external input function list(s) L1 to function(s) listed in the sensitive function list(s) L2. For instance, in an example of a flow illustrated in FIG. 4, an execution path list(s) L3 is obtained.

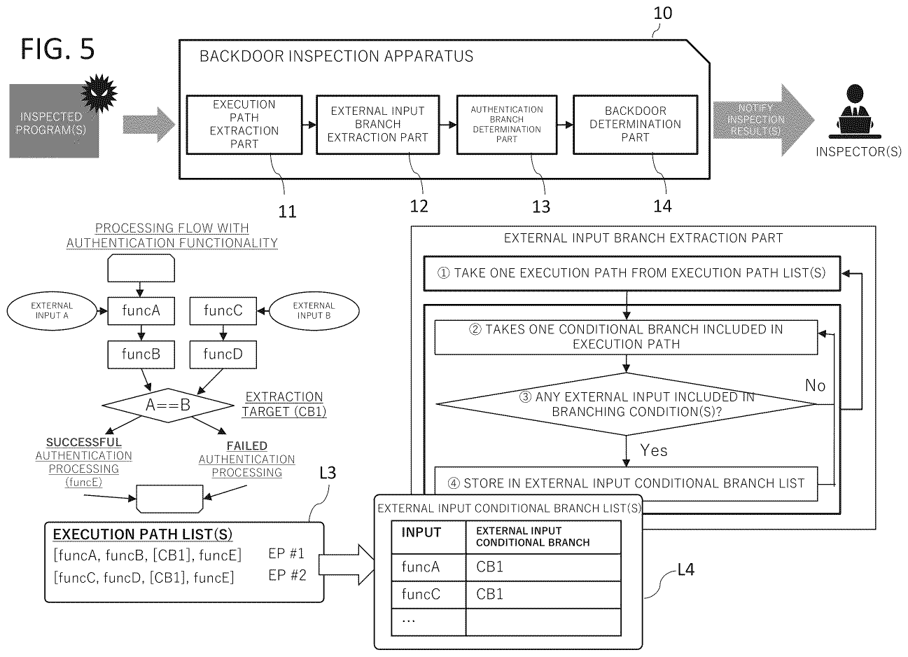

FIG. 5 is a diagram describing a process performed by the external input branch extraction part. As illustrated in a flowchart of FIG. 5, the external input branch extraction part 12 acquires the execution path list(s) generated by the execution path extraction part 11 and takes one execution path from the execution path list(s) (step 1). Next, the external input branch extraction part 12 takes one conditional branch included in the execution path (step 2). Then, the external input branch extraction part 12 determines whether or not the conditional branch includes any external input (step 3). If the conditional branch includes any external input, the external input branch extraction part 12 stores the conditional branch in an external input conditional branch list (step 4). For instance, in the flow example shown in FIG. 5, since a conditional branch CB1 in the execution path list(s) L3 includes external inputs A and B, the conditional branch CB1 is identified as an external input conditional branch and an external input conditional branch list(s) L4 is obtained from the execution path list(s) L3.

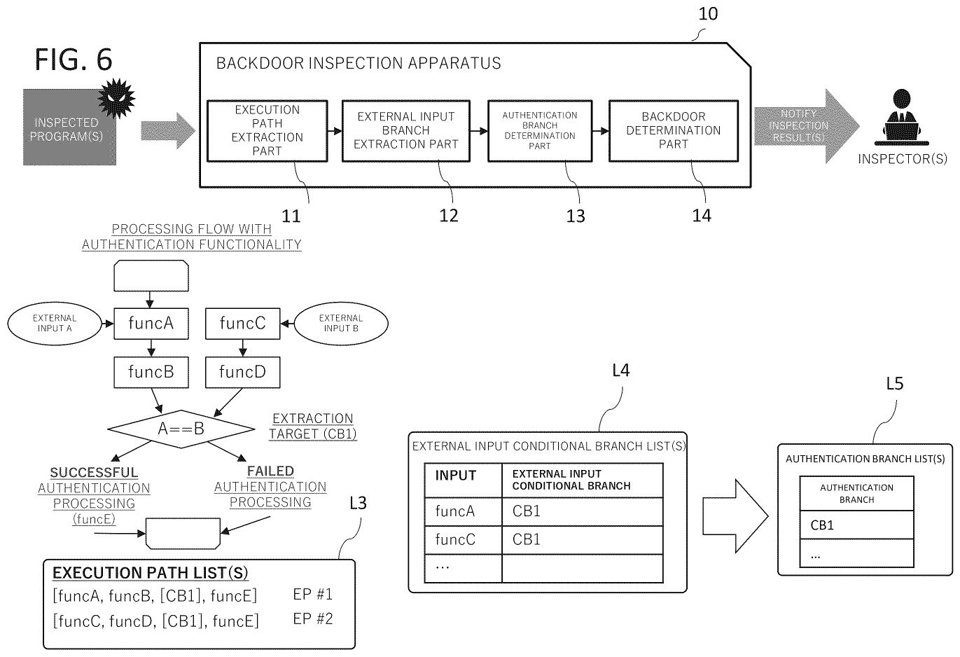

FIG. 6 is a diagram describing a process performed by the authentication branch determination part. The authentication branch determination part 13 extracts conditional branch(es) that includes a plurality of different external inputs as conditions from the external input branch(es) as authentication branch(es) that determines whether authentication succeeds or fails. For instance, in an example of a flow illustrated in FIG. 6, among the external input conditional branches listed in L4, if execution paths share the same external input conditional branch but involve different external inputs, it can be determined that the conditional branch is used to determine authentication success or failure. Therefore, the conditional branch CB1 included in such execution paths is stored in an authentication branch list(s) L5.

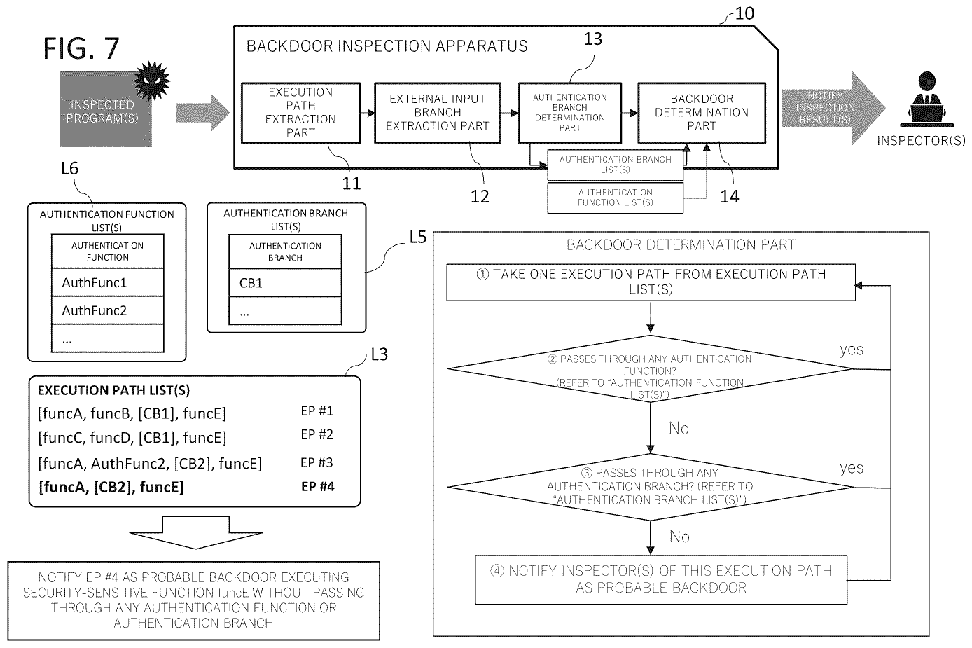

FIG. 7 is a diagram describing a process performed by the backdoor determination part. The backdoor determination part 14 determines any execution path that bypasses both the authentication branch(es) and function(s) used for authentication to be a probable backdoor. As illustrated in FIG. 7, the backdoor determination part 14 uses the execution path list(s) L3 generated by the execution path extraction part 11, the authentication branch list(s) L5 generated by the authentication branch determination part 13, and an authentication function list(s) L6 prepared in advance to identify execution path(s) that is likely to be backdoor(s). As shown in a flowchart of FIG. 7, the backdoor determination part 14 takes one execution path from the execution path list(s) L3 (step 1). Then, the backdoor determination part 14 refers to the authentication function list(s) L6 to determine if the execution path passes through any authentication function (step 2). Further, the backdoor determination part 14 refers to the authentication branch list(s) L5 to determine if the execution path passes through any authentication function (step 3). The backdoor determination part 14 notifies an inspector(s) of any execution path that bypasses all authentication branches and all authentication functions as a probable backdoor (step 4). For instance, in the execution path list L3 shown in FIG. 7, EP #4 executes a security-sensitive function funcE without passing through any authentication function or authentication branch. Therefore, it is notified as a probable backdoor.

By performing backdoor inspection according to the procedure described above, the backdoor inspection apparatus relating to the example embodiment is able to efficiently narrow down execution path(s) that are likely to be backdoor(s), thereby reducing workload involved in backdoor inspection.

### Hardware Configuration

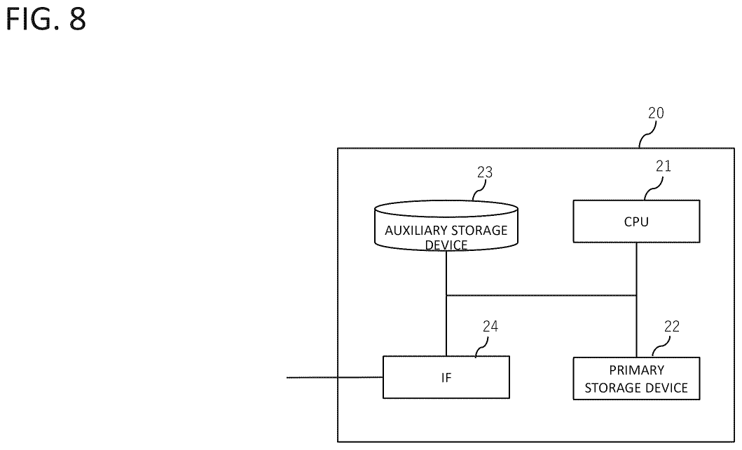

FIG. 8 is a diagram illustrating a hardware configuration example of the backdoor inspection apparatus used in the example embodiment. In other words, the backdoor inspection apparatus 10 is able to achieve each function thereof by causing an information processing apparatus (computer) 20 employing the hardware configuration shown in FIG. 8 to execute the backdoor inspection method described above as a program. It should be noted that the hardware configuration example shown in FIG. 8 is merely an example of the hardware configuration that achieves each function of the backdoor inspection apparatus 10 and is not intended to limit the hardware configuration of the backdoor inspection apparatus 10. The backdoor inspection apparatus 10 may include hardware not shown in FIG. 8.

As shown in FIG. 8, the hardware configuration that may be employed by the backdoor inspection apparatus 10 includes a CPU (Central Processing Unit) 21, a primary storage device 22, an auxiliary storage device 23, and an IF (interface) part 24, which are connected to each other by, for instance, an internal bus.

The CPU 21 executes each instruction included in the backdoor inspection program executed by the information processing apparatus (computer) 20. The primary storage device 22 is, for instance, a RAM (Random Access Memory) and temporarily stores various programs such as the backdoor inspection program executed by the information processing apparatus (computer) 20 so that the CPU 21 can process the program(s).

The auxiliary storage device 23 is, for instance, an HDD (Hard Disk Drive) and is capable of storing various programs, such as the backdoor inspection program executed by the information processing apparatus (computer) 20, in the medium to long term. Various programs such as the backdoor inspection program may be provided as a program product stored in a non-transitory computer-readable storage medium.

The IF part 24 provides an interface related to, for instance, the input and output of the backdoor inspection apparatus 10.

The information processing apparatus (computer) 20 employing the hardware configuration described above achieves each function of the backdoor inspection apparatus 10 by executing the backdoor inspection method described above as a program.

Part or entirety of the example embodiment above can be described as (but not limited to) the following Supplementary Notes.

Supplementary Note 1

A backdoor inspection apparatus, comprising:
an execution path extraction part that analyzes a program(s) to extract execution path (s);
an external input branch extraction part that extracts, as external input branch(es), conditional branch(es) that includes at least one external input as a condition from conditional branch(es) included in the execution path (s);
an authentication branch determination part that extracts conditional branch(es) that includes a plurality of different external inputs as conditions from the external input branch(es) as authentication branch(es) that determines whether authentication succeeds or fails; and a backdoor determination part that determines any execution path that bypasses both the authentication branch(es) and function(s) used for authentication to be a probable backdoor.

### Supplementary Note 2

The backdoor inspection apparatus according to Supplementary Note 1, possibility/possibilities of an execution path(s) being a backdoor(s) by referring to a list(s) of the function(s) used for authentication.

### Supplementary Note 3

The backdoor inspection apparatus according to Supplementary Note 1 or 2, wherein the execution path extraction part refers to a sensitive function list(s) containing critical function(s), to be analyzed, that can have a large impact on a system(s) if exploited and to an external input function list(s) containing function(s) that define variable(s) using external input(s), and extracts execution path(s) that leads from function(s) listed in the external input function list(s) to function(s) listed in the sensitive function list(s).

### Supplementary Note 4

The backdoor inspection apparatus according to any one of Supplementary Notes 1 to 3, wherein the authentication branch determination part extracts, as the authentication branch(es), that/those that compare external input(s) supplied from outside an apparatus(es) executing the program(s) with external input(s) stored internally within the apparatus(es).

### Supplementary Note 5

A backdoor inspection method, comprising:
analyzing a program(s) to extract execution path(s);
extracting as external input branch(es) conditional branch(es) that includes at least one external input as a condition from conditional branch(es) included in the execution path (s);
extracting conditional branch(es) that includes a plurality of different external inputs as conditions from the external input branch(es) as authentication branch(es) that determines whether authentication succeeds or fails; and
determining any execution path that bypasses the authentication branch(es) and function(s) used for authentication to be a probable backdoor.

### Supplementary Note 6

The backdoor inspection method according to Supplementary Note 5, determining a possibility/possibilities of an execution path(s) being a backdoor(s) by referring to a list(s) of the function(s) used for authentication.

### Supplementary Note 7

The backdoor inspection method according to Supplementary Note 5 or 6, referring to a sensitive function list(s) containing critical function(s), to be analyzed, that can have a large impact on a system(s) if exploited and to an external input function list(s) containing function(s) that defines variable(s) using external input(s), and extracting execution path(s) that leads from function(s) listed in the external input function list(s) to function(s) listed in the sensitive function list(s).

### Supplementary Note 8

The backdoor inspection method according to any one of Supplementary Notes 5 to 7, extracting, as the authentication branch(es), that/those that compare external input(s) supplied from outside an apparatus(es) executing the program(s) with external input(s) stored internally within the apparatus(es).

### Supplementary Note 9

A backdoor inspection program, causing an information processing apparatus to execute:
an execution path extraction process of analyzing a program(s) to extract execution path (s);
an external input branch extraction process of extracting as external input branch(es) conditional branch(es) that includes at least one external input as a condition from conditional branch(es) included in the execution path (s);
an authentication branch determination process of extracting conditional branch(es) that includes a plurality of different external inputs as conditions from the external input branch(es) as authentication branch(es) that determines whether authentication succeeds or fails; and
a backdoor determination process of determining any execution path that bypasses the authentication branch(es) and function(s) used for authentication to be a probable backdoor. The backdoor inspection program according to Supplementary Note 9, wherein the backdoor determination process determines a possibility/possibilities of an execution path(s) being a backdoor(s) by referring to a list(s) of the function(s) used for authentication.

Further, the disclosure of Patent Literature cited above is incorporated herein in its entirety by reference thereto. It is to be noted that it is possible to modify or adjust the example embodiments or examples within the scope of the whole disclosure of the present invention (including Claims) and based on the basic technical concept thereof. Further, it is possible to variously combine or select (or partially omit) a wide variety of the disclosed elements (including the individual elements of the individual claims, the individual elements of the individual example embodiments or examples, and the individual elements of the individual figures) within the scope of the whole disclosure of the present invention. That is, it is self-explanatory that the present invention includes any types of variations and modifications to be done by a skilled person according to the whole disclosure including Claims, and the technical concept of the present invention. Particularly, any numerical values or ranges disclosed herein should be interpreted that any intermediate values or subranges falling within the disclosed ranges are also disclosed even without explicit recital thereof. In addition, using some or all of the disclosed elements in each literature cited above as necessary in combination with the elements described herein as part of the disclosure of the present invention in accordance with the object of the present invention shall be considered to be included in the disclosed elements of the present application.

### REFERENCE SIGNS LIST

10: backdoor inspection apparatus
11: execution path extraction part
12: external input branch extraction part
13: authentication branch determination part
20: information processing apparatus
21: CPU
22: primary storage device
23: auxiliary storage device
24: IF part

What is claimed is:

1. A backdoor inspection apparatus, comprising:
an execution path extraction part that analyzes a program(s) to extract execution path(s);
an external input branch extraction part that extracts, as external input branch(es), conditional branch(es) that includes at least one external input as a condition from conditional branch(es) included in the execution path(s);
an authentication branch determination part that extracts conditional branch(es) that includes a plurality of different external inputs as conditions from the external input branch(es) as authentication branch(es) that determines whether authentication succeeds or fails; and
a backdoor determination part that determines any execution path that bypasses both the authentication branch(es) and function(s) used for authentication to be a probable backdoor.

2. The backdoor inspection apparatus according to claim 1, wherein the backdoor determination part determines a possibility/possibilities of an execution path(s) being a backdoor(s) by referring to a list(s) of the function(s) used for authentication.

3. The backdoor inspection apparatus according to claim 1, wherein the execution path extraction part refers to a sensitive function list(s) containing critical function(s), to be analyzed, that can have a large impact on a system(s) if exploited and to an external input function list(s) containing function(s) that define variable(s) using external input(s), and extracts execution path(s) that leads from function(s) listed in the external input function list(s) to function(s) listed in the sensitive function list(s).

4. The backdoor inspection apparatus according to claim 1, wherein the authentication branch determination part extracts, as the authentication branch(es), that/those that compare external input(s) supplied from outside an apparatus executing the program(s) with external input(s) stored internally within the apparatus.

5. A backdoor inspection method, comprising:
analyzing a program(s) to extract execution path(s);
extracting as external input branch(es) conditional branch(es) that includes at least one external input as a condition from conditional branch(es) included in the execution path(s);
extracting conditional branch(es) that includes a plurality of different external inputs as conditions from the external input branch(es) as authentication branch(es) that determines whether authentication succeeds or fails; and
determining any execution path that bypasses the authentication branch(es) and function(s) used for authentication to be a probable backdoor.

6. The backdoor inspection method according to claim 5, determining a possibility/possibilities of an execution path(s) being a backdoor(s) by referring to a list(s) of the function(s) used for authentication.

7. The backdoor inspection method according to claim 5, referring to a sensitive function list(s) containing critical function(s), to be analyzed, that can have a large impact on a system(s) if exploited and to an external input function list(s) containing function(s) that defines variable(s) using external input(s), and extracting execution path(s) that leads from function(s) listed in the external input function list(s) to function(s) listed in the sensitive function list(s).

8. The backdoor inspection method according claim 5, extracting, as the authentication branch(es), that/those that compare external input(s) supplied from outside an apparatus executing the program(s) with external input(s) stored internally within the apparatus.

9. A non-transitory computer readable medium storing a backdoor inspection program, causing an information processing apparatus to execute:
an execution path extraction process of analyzing a program(s) to extract execution path(s);
an external input branch extraction process of extracting as external input branch(es) conditional branch(es) that includes at least one external input as a condition from conditional branch(es) included in the execution path(s);
an authentication branch determination process of extracting conditional branch(es) that includes a plurality of different external inputs as conditions from the external input branch(es) as authentication branch(es) that determines whether authentication succeeds or fails; and
a backdoor determination process of determining any execution path that bypasses the authentication branch(es) and function(s) used for authentication to be a probable backdoor.

10. The non-transitory computer readable medium storing the backdoor inspection program according to claim 9, wherein the backdoor determination process determines a possibility/possibilities of an execution path(s) being a backdoor(s) by referring to a list(s) of the function(s) used for authentication.

11. The non-transitory computer readable medium storing the backdoor inspection program according to claim 9, referring to a sensitive function list(s) containing critical function(s), to be analyzed, that can have a large impact on a system(s) if exploited and to an external input function list(s) containing function(s) that defines variable(s) using external input(s), and extracting execution path(s) that leads from function(s) listed in the external input function list(s) to function(s) listed in the sensitive function list(s).

12. The non-transitory computer readable medium storing the backdoor inspection program according to claim 9, extracting, as the authentication branch(es), that/those that compare external input(s) supplied from outside an apparatus executing the program(s) with external input(s) stored internally within the apparatus.
